(19) United States
(12) Patent Application Publication
(10) Pub. No.: US 2005/0096825 A1
(43) Pub. Date: May 5, 2005

(54) Apparatus and method for preventing vehicle collision using radio communication

(76) Inventor: Soo-Hyuk Lee, Seoul (KR)

Correspondence Address: MORGAN, LEWIS & BOCKIUS LLP (SF), 2 PALO ALTO SQUARE, PALO ALTO, CA, 94306, US

(21) Appl. No.: 10/911,722

(22) Filed: Aug. 4, 2004

(30) Foreign Application Priority Data
Oct. 30, 2003 (KR) 10-2003-076313

(51) Int. Cl. G06F 7/70

(52) U.S. Cl. 701/70; 701/301

(57) ABSTRACT

An apparatus for preventing a vehicle collision by using radio communication includes an accelerator pedal sensor for detecting the manipulation state of an accelerator pedal. A control unit receives a signal detected by the accelerator pedal sensor and determines whether the vehicle is in a dangerous condition for outputting a relevant control signal. A radio communication transmitting/receiving module receives the control signal from the control unit and transmits or receives the information to or from vehicles of its dangerous condition. A Hydraulic Control Unit (HCU) receives the control signal of the control unit and maintains the brake system in a standby operating mode. When the information of a prospective hazardous condition is transmitted from the front vehicle, the brake systems of rear vehicles are pre-pressured and are shifted to a standby operating mode, thereby reducing the braking distance of the vehicles and preventing vehicle accidents.

### CROSS-REFERENCE TO RELATED APPLICATIONS

This application claims priority of Korean Application No. 10-2003-0076313, filed on Oct. 30, 2003, the disclosure of which is incorporated fully herein by reference.

### FIELD OF THE INVENTION

The present invention relates to an apparatus and a method for preventing a vehicle collision by using radio communication. More particularly, the present invention relates to a brake system adapted to be in a standby operating mode when a collision is expected, thereby reducing the braking distance.

### BACKGROUND OF THE INVENTION

In general, a driver depresses a brake pedal when he or she recognizes the need to slow down or stop the vehicle due to external environmental factors (e.g., road conditions, car accident, other vehicles' conditions and the like). If the driver pushes down the brake pedal, the vehicle's rear brake lights illuminate. This alerts vehicles driving behind that the front vehicle is slowing down or stopping.

However, when the front vehicle makes a sudden stop or a safe distance between vehicles is not obtained in congested traffic, vehicles are subject to collide with each other due to visual impediments by the front vehicle or slow braking operation. Accordingly, in order to prevent a vehicle accident, the braking distance should be reduced.

A Brake Assist System (BAS) configured to greatly adjust the boosting ratio of a booster during a sudden stop of a vehicle is conventionally used to diminish the braking distances in an emergency. However, since the BAS increases the initial braking force during the manipulation of the pedal, the system cannot prevent bumper collisions when vehicles driving behind suddenly depress their pedals.

### SUMMARY OF THE INVENTION

Embodiments of the present invention provide an apparatus and a method for preventing a vehicle collision by using radio communication. The present invention is adapted to transmit through radio communication the prospective emergency condition of a front vehicle (e.g., a sudden stop) to vehicles driving behind, thereby rendering brake systems of the vehicles to be in a standby operating mode and reducing the braking distance.

An apparatus for preventing a vehicle collision by using radio communication according to an exemplary embodiment of the present invention comprises an accelerator pedal sensor for detecting the manipulation state of an accelerator pedal. A control unit receives a signal detected through the accelerator pedal sensor and determines whether the vehicle is in a dangerous condition for outputting a relevant control signal. A radio communication transmitting/receiving module receives the control signal from the control unit and transmits or receives the information of a dangerous condition to or from vehicles. A Hydraulic Control Unit (HCU) receives the control signal of the control unit and maintains a brake system in a standby operating mode.

The control unit includes an accelerator pedal releasing speed enumerator that receives a signal from the accelerator pedal sensor and enumerates the releasing speed of the accelerator pedal. An accelerator pedal releasing speed comparator compares the value of the releasing speed of the accelerator pedal and the predetermined standard value. A hazardous condition instrument determines on the basis of the result from the accelerator pedal releasing speed comparator whether the value of the releasing speed of the accelerator pedal exceeds the standard value. If the value of the releasing speed of the accelerator pedal exceeds the standard value, then this indicates that the vehicle is in danger.

A method for preventing a vehicle collision by using radio communication, comprises the steps of transmitting or receiving the information of a hazardous condition of nearby vehicles on the basis of the releasing speed of an accelerator pedal and maintaining a brake system in a standby operating mode when the information of the hazardous condition is transmitted from a nearby vehicle.

The method further comprises the steps of enumerating the releasing speed of the accelerator pedal; comparing the releasing speed of the accelerator pedal and the standard value; and transmitting the information of the hazardous condition to nearby vehicles and maintaining the brake system in a standby operating mode if the releasing speed of the accelerator pedal is larger than the standard value.

Finally, the method comprises the step of releasing the standby operating mode of the brake system if the brake system is in a standby operating mode and the brake pedal does not operate within a predetermined time.

### BRIEF DESCRIPTION OF THE DRAWINGS

For a better understanding of the nature and objects of the present invention, reference should be made to the following detailed description with the accompanying drawings, in which:

FIG. 1 is a block diagram of an apparatus for preventing a vehicle collision by using radio communication according to an embodiment of the present invention;

FIG. 2 is a flowchart of a method for preventing a vehicle collision by using radio communication according to an embodiment of the present invention; and

FIG. 3 illustrates the components that determine a braking distance of a vehicle.

### DETAILED DESCRIPTION OF THE PREFERRED EMBODIMENTS

A preferred embodiment of the present invention will now be described in detail with reference to the attached drawings.

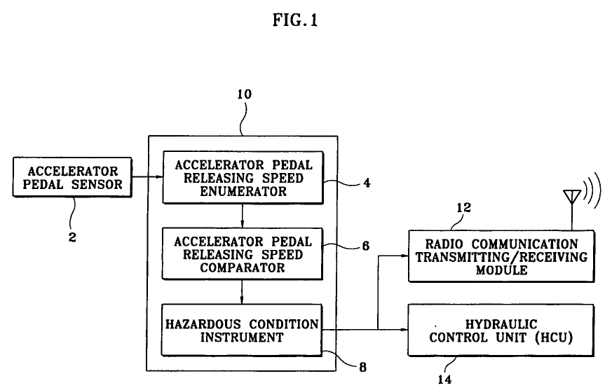

Referring to FIG. 1, an apparatus for preventing a vehicle collision by using radio communication according to an exemplary embodiment of the present invention comprises an accelerator pedal sensor 2 for detecting the manipulation state of an accelerator pedal. A control unit 10 receives a signal detected through the accelerator pedal sensor 2 and determines whether the vehicle is in a dangerous condition for outputting a relevant control signal. A radio communication transmitting/receiving module 12 receives the control signal from the control unit 10 and transmits or receives the information to or from vehicles under dangerous conditions. A Hydraulic Control Unit (HCU) 14 receives the control signal of the control unit 10 and maintains a brake system in a standby operating mode.

The control unit 10 according to an embodiment of the present invention includes an accelerator pedal releasing speed enumerator 4 for receiving a signal from the accelerator pedal sensor 2 and for enumerating a releasing speed of the accelerator pedal. An accelerator pedal releasing speed comparator 6 compares the value of the releasing speed of the accelerator pedal and the predetermined standard value, wherein the releasing speed of the accelerator pedal is enumerated through the accelerator pedal releasing speed enumerator 4. A hazardous condition instrument 8 determines on the basis of the result from the accelerator pedal releasing speed comparator 6 whether the value of the releasing speed of the accelerator pedal exceeds the standard value. If the value of the releasing speed of the accelerator pedal exceeds the standard value, then this indicates that the vehicle is in danger.

Control units for use with the present invention may be selected by persons of ordinary skill in the art based on the teachings contained herein. The control units may include appropriately selected components such as processors, memory and associated hardware programmed by a person skilled in the art.

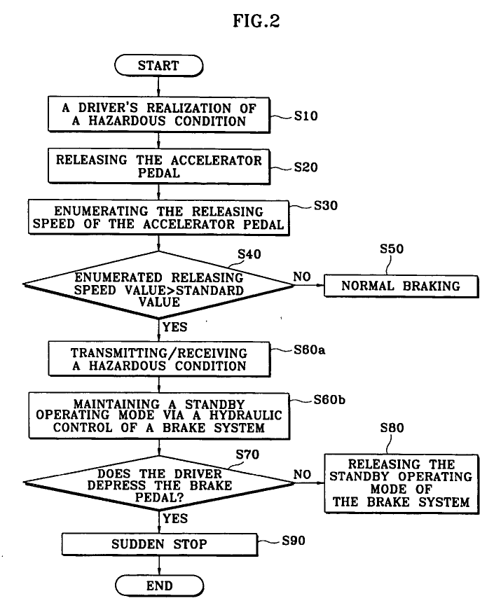

A method for preventing a vehicle collision by using radio communication according to the present invention will now be described with reference to the flowchart of FIG. 2. If the driver realizes that the vehicle is in a hazardous condition (S10), the driver executes an accelerator pedal releasing step by removing his or her foot from the accelerator pedal (S20).

If the accelerator pedal is released at step 20, the control unit receives a signal from an accelerator pedal sensor and enumerates the releasing speed of the accelerator pedal (S30). Then, the control unit compares the enumerated releasing speed value of the accelerator pedal and the predetermined standard value (S40). This step determines the prospective dangerous condition of a sudden braking.

As a result of step 40, if the releasing speed value of the accelerator pedal enumerated through the control unit is smaller than the predetermined standard value, a normal braking is performed since the driving condition is not recognized as dangerous as to make a sudden stop (S50). On the other hand, if the value of the enumerated releasing speed of the accelerator pedal is larger than the predetermined standard value, this indicates that the front vehicle is in a prospective hazardous condition (e.g., a sudden stop).

Provided that step 40 determines that the vehicle is in a hazardous condition, a hazardous condition warning is transmitted to or received from nearby vehicles through a radio communication transmitting/receiving module (S60a).

If the vehicle is in danger as a result of step 40, both the brake systems of the front and rear vehicles, where one transmits the hazardous condition warning and the other receives the transmitted signal, will shift to standby operating mode via the HCU (S60b).

Accordingly, before the driver steps his or her foot on the brake pedal, the HCU reduces clearance between a brake pad and a disk by pre-pressuring the hydraulic pressure of the brake system, resulting in a maintenance of the brake system in a standby operating mode.

By way of reference, S60a and S60b are represented in the flowchart of FIG. 2 as two independent steps, however, these steps are preferably performed almost simultaneously.

After maintaining the brake system in a standby operating mode at S60b, whether the operation of the driver's brake pedal is carried out within a predetermined time is determined (S70). Then, if the brake pedal is operated within the predetermined time, a sudden stop is made by a generation of the rapid braking force (S90). On the other hand, if the brake pedal does not operate within the predetermined time, the standby operating mode of the brake system is released (S80). That is because the hazardous condition warning transmitted from a front vehicle is not only transmitted to the directly behind vehicle but also to other nearby vehicles. Therefore, this step releases the standby operating mode of the brake system in vehicles not requiring a sudden brake.

Thus, the present invention prohibits vehicle collisions by transmitting the dangerous condition warning of a front vehicle to nearby vehicles; and sustaining the brake system in a standby operating mode for vehicles requiring a sudden brake.

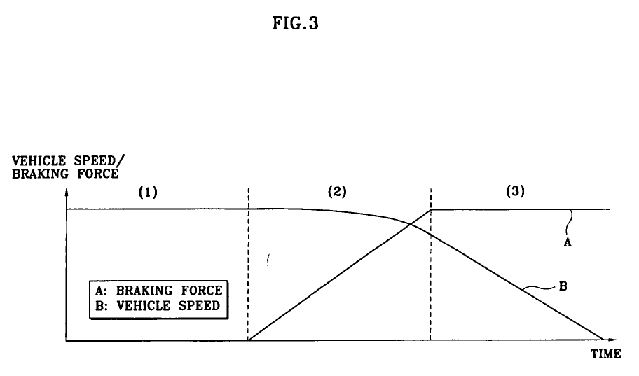

With reference to FIG. 3, the braking distance of a vehicle can be represented by the sum of a driver's initial reaction 1, braking build up time 2, and deceleration time 3. In the driver's initial reaction 1, the driver recognizes a hazardous condition and moves his/her right foot onto the brake pedal. The braking build up time 2 represents the time period starting from the contact of the driver's foot on the brake pedal until the braking effect is completely applied. The deceleration time 3 represents the time period starting from the complete application of the frictional force onto the disk drum until the vehicle comes to a complete stop.

When danger is expected to occur in a vehicle, the present invention renders the brake system to a standby operating mode in order to reduce the braking build up time 2 and braking distance of the vehicle, thereby preventing a vehicle collision.

The technical aspects of the present invention are not limited to the exemplary embodiment of the present invention, however, technical scope should be decided according to logical interpretations of the matter described in claims.

As apparent from the foregoing, there is an advantage in the present invention in that the brake system according to the embodiment of the present invention promptly transmits a generated hazardous information from a front vehicle to rear vehicles via radio communication and reduces the operation time of a brake system by transferring the brake system to a standby operating mode, thus preventing vehicle collision.

There is another advantage in that the brake system according to the embodiment of the present invention can be embodied by a communication system expected to be widely used in vehicles and a modification of a pre-mounted control logic of the brake system, thus avoiding any increase in weights and manufacturing costs by additional apparatus.

1. An apparatus for preventing a vehicle collision by using radio communication, comprising:
an accelerator pedal sensor for detecting the manipulation state of an accelerator pedal;
a control unit receiving a signal detected by said accelerator pedal sensor and determining whether the vehicle is in a dangerous condition for outputting a relevant control signal;
a radio communication transmitting/receiving module for receiving the control signal from said control unit and transmitting or receiving information indicating a dangerous condition to or from nearby vehicles; and
a Hydraulic Control Unit receiving the control signal of said control unit and maintaining a brake system in a standby operating mode in response to said control signal.

2. The apparatus as defined in claim 1, wherein said control unit includes:
an accelerator pedal releasing speed enumerator receiving a signal from said accelerator pedal sensor and enumerating a releasing speed of said accelerator pedal;
an accelerator pedal releasing speed comparator for comparing the value of the releasing speed of said accelerator pedal and the predetermined standard value; and
a hazardous condition instrument for determining on the basis of the result from said accelerator pedal releasing speed comparator whether the value of the releasing speed of said accelerator pedal exceeds the standard value, wherein an exceeding value indicates that the vehicle is in danger.

3. A method for preventing a vehicle collision by using radio communication, comprising:
transmitting or receiving information of a hazardous condition to or from nearby vehicles on the basis of a releasing speed of an accelerator pedal; and
maintaining a brake hydraulic system in a standby operating mode when the information of a hazardous condition is received from a nearby vehicle.

4. The method as defined in claim 3, further comprising:
enumerating the releasing speed of said accelerator pedal;
comparing the releasing speed of said accelerator pedal and the standard value; and
transmitting the information of a hazardous condition to nearby vehicles and maintaining said brake system in a standby operating mode if the releasing speed of said accelerator pedal is larger than the standard value.

5. The method as defined in claim 3, further comprising:
releasing the standby operating mode of said brake system if said brake system is in a standby operating mode and said brake pedal does not operate within a predetermined time.

6. The method as defined in claim 4, further comprising:
releasing the standby operating mode of said brake system if said brake system is in a standby operating mode and said brake pedal does not operate within a predetermined time.
